(19) United States
(12) Patent Application Publication
(10) Pub. No.: US 2026/0296791 A1
(43) Pub. Date: Oct. 1, 2026

(54) METHOD AND SYSTEM FOR ORDER PICKING

(71) Applicant: FIVES SYLEPS, Lorient (FR)

(72) Inventors: Abdessamad OUZIDAN, Lorient (FR); Bérenger DAVID, Lorient (FR)

(21) Appl. No.: 19/489,124

(22) PCT Filed: May 31, 2024
(86) PCT No.: PCT/EP2024/065085

§ 371 Date: Dec. 1, 2025

(30) Foreign Application Priority Data
Jun. 1, 2023 (FR) FR2305501

(51) Int. Cl. B65G 1/137; B65G 1/04

(52) U.S. Cl. CPC B65G 1/1378; B65G 1/0492

(57) ABSTRACT

A system and method for picking orders which comprises a calculation step for determining an optimized order for picking the orders and a step of picking the orders using the results of the calculation step. The calculation step including consulting a list of orders pending picking, verifying the availability of one or more empty locations at the order-picking station selecting the next order (O₁, O₂, O₃, O₄, O₅) to be placed in each available location at the order-picking station, taking out containers comprising products of a priority order corresponding to the order having the fewest different products, and when the priority order is complete, it is discharged to a delivery zone.

### TECHNICAL FIELD OF THE INVENTION

The invention relates to the field of logistics platforms for large and medium-sized retailers and relates to a method and a system for picking orders.

### STATE OF THE ART

Logistics platforms act as intermediaries between suppliers and points of sale. Generally, the suppliers transport their products to these platforms where they are received and processed to be placed in storage. Then, points of sale send their supply requests to these platforms. For each order, the requested products are taken from the storage zone to be transported to an order-picking zone. In the picking zone, pickers or robots are used to place the products in shipping containers which will then be transported to their destination.

Order picking is one of the most important and the most expensive activities of a logistics platform; its cost can account for more than half the total cost of a warehouse. This task therefore needs to be optimized to make order picking more efficient and less expensive.

The aim of the invention is therefore to propose a system and a method for picking orders that will enable the problem hereinbefore to be solved.

### SUMMARY OF THE INVENTION

To this end, the invention relates, according to a first aspect, to a method for picking a set of orders using an order-picking system comprising:
a product storage zone in which products are placed in storage containers, each storage container comprising a single type of product,
an order-picking station comprising one or more locations for order containers, in each location, products of an order are transferred (for example by a robot or by an operator) into an order container from one or more storage containers,
transport means for moving storage containers between the storage zone and the order-picking station, and
computerized control means,
the method being implemented by the computerized control means and comprises a first calculation step and a second order-picking step by applying the results of the first step,
in the first step, the computerized control means determine an optimized order for picking the orders and an optimized order for transferring products between the storage zone (for example an AMR moves a container comprising one type of product) and the order-picking station by executing the following sub-steps:
(a) consulting the list of orders pending picking,
(b) verifying the presence of at least one order at the order-picking station,
(c) verifying the availability of one or more location(s) at the order-picking station,
(d) selecting an order pending picking to be placed in an available location, the selected order being the best correlated with the orders being picked, this step being repeated successively for each available location at the order-picking station,
(e) when each picking location is occupied by an order to be picked or when there are no more orders waiting to be picked:
selecting from said orders at the picking station, a priority order to be picked corresponding to the order requiring the fewest different products,
selecting an order from the storage containers comprising products from said priority order, to be removed one by one from the storage zone to transfer them to the order-picking station, each storage container comprising a product being intended to serve all orders being picked requiring said product before being returned to stock,
(f) when said priority order no longer requires products, it is considered complete and discharged to free up a location at the order-picking station, with the sub-steps (a) to (f) repeated until a picking order is obtained for all the orders in the list and a product transfer order is obtained between the storage zone and the order-picking station.

In the second step, the computerized control means control the product storage zone, the order-picking station and the transport means to pick the orders according to the picking order and the product transfer order between the storage zone and the order-picking station, resulting from the calculation in the first step.

The correlation quoted in step (d) means that the order selected is the one that best shares the demand with the orders being picked. In other words, the order that has the most products in common with the orders which are already being picked at the order-picking station.

The method according to the invention optimizes the order in which the orders are picked as well as the order in which the products are moved from stock to the picking station and returned to stock if the container still comprises products. This reduces the need for storage containers to go back and forth between the warehouse and the picking station and the orders are processed quickly.

For example, by serving the order requiring the fewest different products, it is possible to quickly free up a location in the order-picking station to send out a new order, thus taking advantage of the next containers transferred from the storage zone to the order-picking station to serve an additional order. This therefore reduces the number of return trips to stock.

The calculation step can be, for example, a simulation step in which the order-picking is simulated before the actual picking so as to determine an optimum order for picking the orders and an optimum order for moving the products between the storage zone and the order-picking station.

Optionally, if no order is present in the picking locations at the time of the verification, an order to be placed is randomly selected from the list of orders pending picking.

Advantageously, in sub-step (e):
for each product in the priority order, a demand score is calculated by the orders pending picking,
the storage container of a product having a highest score is selected as the last to be transferred from the storage zone to the order-picking station,
an order comprising said last product is selected to be the next order to be sent to the picking station after step (f), and
the storage container comprising said last product is kept at the picking station to serve said next order before being returned to stock.

The product to be taken out last will be used for the next order and therefore further reduces the number of return trips to stock.

Advantageously, the order demand is represented by a matrix denoted

$$Q = {( {q}_{i , j} )}_{1 \leq i \leq {n}^{′} , 1 \leq j \leq m}$$

with q_{i,j}=1 if order i requires product j, otherwise q_{i,j}=0,
the score for a product j (for example j=product B) is given by the following formula:

$$S ( j ) = {\sum }_{i} {q}_{i , j}$$

The invention also relates to a computer program comprising instructions which, when the program is executed by a computer, cause the computer to execute steps a) to f) of the order-picking method.

It also relates to a computer-readable medium on which the computer program hereinbefore is saved.

The invention also relates to a system for picking orders comprising:
a product storage zone in which products are placed in storage containers, each storage container comprising a single type of product,
an order-picking station comprising one or more order container locations, in each location, products for an order can be transferred into the order container from one or more storage containers,
transport means configured to move the storage containers between the storage zone and the order-picking station,
a computerized control means configured to execute the steps of one of the methods hereinbefore.

Advantageously, the means of transport may comprise an Autonomous Mobile Robot (AMR), an Automated Guided Vehicle (AGV) or a conveyor.

Such means make it possible to automate and streamline the movement of storage containers and those of orders.

Advantageously, the order-picking station can comprise a robot equipped with a gripper for transferring one or more products at a time from a storage container to an order container. The gripper can be configured to pick up whole layers or individual products. This thus automates palletizing.

### BRIEF DESCRIPTION OF THE FIGURES

Further features and advantages of the invention will become apparent from the following description in relation to the appended drawing:

FIG. 1 shows an example of a system for picking orders according to the invention.

This example is given by way of non-limiting example.

### DETAILED DESCRIPTION

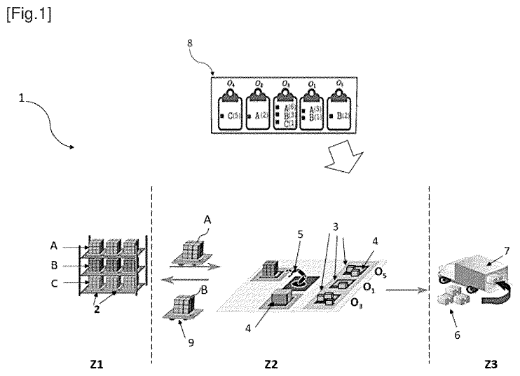

FIG. 1 depicts an example of a system for picking orders in accordance with the invention. The system 1 comprises a product storage zone Z1 wherein products A, B, C are placed in storage containers 2. In the example, each storage container 2 comprises a single type of product A, B, C. The storage containers are for example pallets. For example, the zone Z1 comprises containers on each level filled with a single type of product A, B, C.

The system also comprises a second zone Z2 known as an order-picking station. This zone Z2 comprises locations 3 for order containers 4, the locations are intended to receive empty order containers 4 to enable order picking.

Additionally, the order-picking station may comprise an order picker or a robot 5 as shown in the example. The robot 5 can be fitted with a gripper to transfer one or more products A, B, C at a time from a storage container 2 to the order containers 4. Palletizing can be for example in layers of products.

The system also comprises a third zone Z3, known as the delivery zone, which can accommodate for example delivery trucks 7 that receive the finished orders 6 for delivery to customers.

The system 1 also comprises transport means 9 for moving the storage containers 2 between the storage zone Z1 and the order-picking station Z2. The transport means 9 may for example comprise one or more Autonomous Mobile Robots (AMRs), an Automated Guided Vehicle (AGVs) or a conveyor. Similar means of transport can also be provided between the order-picking station Z2 and the delivery zone Z3.

The system also comprises a computerized control system for monitoring the method for picking orders.

The method for picking a set of orders O₁, O₂, O₃, O₄, O₅ using this system involves two steps:
A calculation step, wherein a set of sub-steps are executed to obtain an optimized order for picking orders and an optimized order for moving containers of products between the storage zone and the order-picking station, the movement being for example by the use of AMRs.
A second step of picking orders O₁, O₂, O₃, O₄, O₅ by applying the results of the first step.

### Calculation Step

The calculation step comprises the following sub-steps:
(a): consulting a list of orders O₁, O₂, O₃, O₄, O₅ pending picking. Each order is made up of one or more products A, B, C, and each product can be requested in a certain quantity. For example, in list 8, order O₅ requests only product B with a quantity of 2, while order O₃ requests products A, B, C with quantities of 6, 3 and 1 respectively.
(b): verifying the presence of at least one order O₁, O₂, O₃, O₄, O₅ at picking station Z2, i.e. at least one of locations 3 is occupied by an order when the list of orders pending picking is consulted,
If no order is present, the first order can be selected randomly or according to other strategies.
(c): verifying the availability of location(s) 3 at the order-picking station Z2. If all locations 3 are occupied, it will not be necessary to send a new order to be picked; if a location is free, a decision can be taken by the computer program to send a new order from the pending list in the next step,
(d): a successive selection of orders pending picking O₁, O₂, O₃, O₄, O₅ to be placed in each available location 3 at the picking station Z2. The order selected for placement is the one which comprises the most products in common with the order(s) already present at the picking station. For example, if there are two remaining orders requiring products A, B, C and A, C respectively, the program will give preference to an order requesting either product A alone, product C alone or both products A and C.
(e): when all the locations in the order-picking station are occupied, for example in the case shown, three orders O₅, O₁ and O₃ are present, the containers 2, each comprising a single type of product A, B, C are transferred from the storage zone one by one to pick the orders that are present in the order-picking station.

The order in which the storage containers are transferred from the storage zone to the picking station is selected to ensure that a location is freed up as soon as possible. To do this, the program compares the orders placed at the picking station Z2 and selects the one requiring the fewest different products and designates it as the order to be processed as a priority, as it will quickly free up a location 3. For example, from the orders O₅, O₁ and O₃, present in locations 3, the priority order is O₅ because it corresponds to the order having the fewest different products. Indeed, O₅ only requires product B.

Once the priority order has been designated, the containers of products required by this order are transferred from the storage zone one by one. Each storage container 2 comprising a single type of product A, B, C moved to the order-picking station serves all orders requiring this product before being returned to stock. For example, a container of product B is taken from stock to serve orders O₅, O₁ and O₃ before returning to the storage zone Z1. Thus, product B serves all three orders and quickly frees up the location for priority order O₅ which only requires this product, which enables the program to place a new order at the picking station following steps (c) and (d).

Step (e) may further comprise optional sub-steps wherein:
for each product B of the priority order O₅, a demand score is calculated by the orders pending picking Z2, i.e. for each product requested by the priority order, the program looks in the pending orders to see if they are also requesting this product, for example if order O₅ is the priority order, then the score is calculated for the demand for product B in the remaining orders in the waiting list,
The storage container 2 of a product having a highest score is selected to be the last to be transferred from the storage zone,
An order comprising said last product is selected to be the next order to be sent to the picking station Z2 after step (f), and
the storage container 2 comprising said last product is kept at the picking station to serve said next order before being returned to stock.

Advantageously, the demand for orders can be represented by a matrix denoted:

$$Q = {( {q}_{i , j} )}_{1 \leq i \leq {n}^{′} , 1 \leq j \leq m}$$

The number n′ being the number of orders waiting to be placed at the order-picking station, m being the total number of different products.

In this case, q_{i,j}=1 if order i requires product j, otherwise q_{i,j}=0.

The score can be given by the following formula:

$$S ( j ) = {\sum }_{i} {q}_{i , j}$$

(f): When the priority order O5 no longer requires any products, it is considered complete and discharged to free up a location at the order-picking station.

Sub-steps (a) to (f) are repeated until an optimized picking order is obtained for all orders O₁, O₂, O₃, O₄, O₅ in the list and an optimized order is obtained for transferring products A, B, C between the storage zone and the order-picking station.

### Order-Picking Step

In the second step, the computerized control means control the product storage zone Z1, the order-picking station Z2 and the transport means 9, for example AMRs to pick orders O₁, O₂, O₃, O₄, O₅.

Order picking is carried out according to the picking order and the order for transferring products A, B, C between the storage zone and the order-picking station, resulting from the calculation in the calculation step.

Thus, order picking is more efficient, and the number of AMRs needed to move the storage containers is optimized.

1. A method for picking a set of orders (O₁, O₂, O₃, O₄, O₅) using a system for picking orders comprising:
a product storage zone in which products (A, B, C) are placed in storage containers, each storage container comprising a single type of product (A, B, C),
an order-picking station comprising one or more locations for placing order containers, in each location, products (A, B, C) requested by an order are transferred into an order container from one or more storage containers,
transport means for moving storage containers between the storage zone and the order-picking station, and
computerized control means,
the method being implemented by the computerized control means and comprises a first calculation step and a second step of picking the orders (O₁, O₂, O₃, O₄, O₅) by applying the results of the first step,
in the first step, the computerized control means determine an optimized order for picking the orders (O₁, O₂, O₃, O₄, O₅) and an optimized order for transferring the products (A, B, C) between the storage zone and the order-picking station by executing the following sub-steps:
(a) consulting the list of orders (O₁, O₂, O₃, O₄, O₅) pending picking,
(b) verifying the presence of at least one order (O₁, O₂, O₃, O₄, O₅) at the order-picking station,
(c) verifying the availability of location(s) at the order-picking station,
(d) selecting an order (O₁, O₂, O₃, O₄, O₅) pending picking to be placed in an available location, the selected order being the best correlated with the orders being picked, this step being repeated successively for each available location at the order-picking station,
(e) when each picking location is occupied by an order (O₁, O₂, O₃, O₄, O₅) to be picked or when there are no more orders pending picking:
selecting a priority order (O₅) to be picked from said orders at the picking station, corresponding to the order requiring the fewest different products,
selecting an order of storage containers comprising products (A, B, C) requested by said priority order, to be taken one by one from the storage zone and transferred to the order-picking station, each storage container comprising a single product type (A, B, C) being intended to serve all orders pending picking requiring said product (A, B, C) before being returned to stock,
(f) when said priority order no longer requires products, it is considered complete and discharged to free up at location at the order-picking station,
sub-steps (a) to (f) being repeated until a picking order is obtained for all the orders (O₁, O₂, O₃, O₄, O₅) in the list and a transfer order is obtained for the products (A, B, C) between the storage zone and the order-picking station,
in the second step, the computerized control means control the product storage zone, the order-picking station and the transport means to pick the orders (O₁, O₂, O₃, O₄, O₅) according to the picking order and the order for transferring the products (A, B, C) between the storage zone and the order-picking station, resulting from the calculation in the first step.

2. The method according to claim 1, wherein in sub-step (e):
for each product (B) in the priority order (O₅), a demand score is calculated by the orders pending picking,
the storage container of a product having a highest score is selected to be the last to be transferred from the storage zone,
an order comprising said last product is selected to be the next order to be sent to the picking station after step (f), and
the storage container comprising said last product is kept at the picking station to serve said next order before being returned to stock.

3. The method according to claim 2 wherein, the demand for the products in the list of orders being represented by a matrix denoted
$$Q = {( {q}_{i , j} )}_{1 \leq i \leq {n}^{′} , 1 \leq j \leq m}$$
with q_{i,j}=1 if order i requires product j, otherwise q_{i,j}=0,
the score is given by the following formula:
$$S ( j ) = {\sum }_{i} {q}_{i , j}$$

4. A computer program comprising instructions which, when the program is executed by a computer, cause the computer to execute steps a) to f) of the method for picking orders according to claim 1.

5. A computer-readable medium on which the computer program according to claim 1 is saved.

6. A system for picking orders comprising:
a storage zone for products (A, B, C) in which products are placed in storage containers, each storage container comprising a single type of product (A, B, C),
an order-picking station comprising one or more locations for an order container, in each location, products (A, B, C) of an order (O₁, O₂, O₃, O₄, O₅) can be transferred into the order container from one or more storage containers,
transport means configured to move the storage containers between the storage zone and the order-picking station, and
a computerized control means configured to execute the steps of the order-picking method according to claim 1.

7. The system for picking orders according to claim 1, wherein the transport means comprise an Autonomous Mobile Robot (AMR), an Automated Guided Vehicle (AGV) or a conveyor.

8. A system for picking orders according to claim 6 wherein the order-picking station comprises a robot equipped with a gripper for transferring one or more products at a time from a storage container to an order container.

9. A computer-readable medium on which the computer program according to claim 2 is saved.

10. A computer-readable medium on which the computer program according to claim 3 is saved.

11. A computer-readable medium on which the computer program according to claim 4 is saved.

12. A system for picking orders comprising:
a storage zone for products (A, B, C) in which products are placed in storage containers, each storage container comprising a single type of product (A, B, C),
an order-picking station comprising one or more locations for an order container, in each location, products (A, B, C) of an order (O₁, O₂, O₃, O₄, O₅) can be transferred into the order container from one or more storage containers,
transport means configured to move the storage containers between the storage zone and the order-picking station, and
a computerized control means configured to execute the steps of the order-picking method according to claim 2.

13. A system for picking orders comprising:
a storage zone for products (A, B, C) in which products are placed in storage containers, each storage container comprising a single type of product (A, B, C),
an order-picking station comprising one or more locations for an order container, in each location, products (A, B, C) of an order (O₁, O₂, O₃, O₄, O₅) can be transferred into the order container from one or more storage containers,
transport means configured to move the storage containers between the storage zone and the order-picking station, and
a computerized control means configured to execute the steps of the order-picking method according to claim 3.

14. The system for picking orders according to claim 2, wherein the transport means comprise an Autonomous Mobile Robot (AMR), an Automated Guided Vehicle (AGV) or a conveyor.

15. The system for picking orders according to claim 3, wherein the transport means comprise an Autonomous Mobile Robot (AMR), an Automated Guided Vehicle (AGV) or a conveyor.

16. The system for picking orders according to claim 4, wherein the transport means comprise an Autonomous Mobile Robot (AMR), an Automated Guided Vehicle (AGV) or a conveyor.

17. The system for picking orders according to claim 5, wherein the transport means comprise an Autonomous Mobile Robot (AMR), an Automated Guided Vehicle (AGV) or a conveyor.

18. The system for picking orders according to claim 6, wherein the transport means comprise an Autonomous Mobile Robot (AMR), an Automated Guided Vehicle (AGV) or a conveyor.

19. A system for picking orders according to claim 7 wherein the order-picking station comprises a robot equipped with a gripper for transferring one or more products at a time from a storage container to an order container.
